(19) United States
(12) Patent Application Publication
(10) Pub. No.: US 2005/0244607 A1
(43) Pub. Date: Nov. 3, 2005

(54) Aesthetic and informational protective pole wrap

(76) Inventors: Ray R. Irvin, Indianapolis, IN (US); Richard E. Lutin, Indianapolis, IN (US)

Correspondence Address: BARNES & THORNBURG, 11 SOUTH MERIDIAN, INDIANAPOLIS, IN, 46204, US

(21) Appl. No.: 11/116,784

(22) Filed: Apr. 28, 2005

Related U.S. Application Data
(60) Provisional application No. 60/566,524, filed on Apr. 29, 2004.

(51) Int. Cl. B32B 3/06

(52) U.S. Cl. 428/99

(57) ABSTRACT

An aesthetic and protective wrap for structures such as utility poles, support members, and other structures is provided. The wrap is advantageous for use on structures located along thoroughfares where unauthorized and unsightly posters and handbills often visually clutter the area. The semirigid wrap includes a single or multilayered panel which is wrapped around the circumference of a structure, is resistant to penetration by staples, and may include anti-graffiti and other protective coatings. Additionally, the wrap may include aesthetic content or features which are decorative and/or informational. The content may include art and/or information that is culturally, socially, or commercially useful. The wrap can be retained to the structure by tamper-resistant fasteners or adhesive.

### CROSS-REFERENCE TO RELATED U.S. PATENT APPLICATION

This application claims the benefit of U.S. Provisional Patent Application Ser. No. 06/566,524, filed on Apr. 29, 2004.

### BACKGROUND

The present invention relates to signage and protective coverings for utility poles and other support structures.

Utility poles and other structures located along thoroughfares are subject to unauthorized and unsightly posting of posters and handbills. Posting of such materials leads to a cluttered and unattractive eyesore, especially in neighborhoods and business districts having heavy pedestrian traffic. Even if posters and handbills are regularly removed from utility poles, the build-up of staples and other fastening devices remains an unsightly and potentially dangerous condition.

### SUMMARY

An aesthetic and protective wrap for structures such as utility poles, support members, and other structures is advantageous for use on structures located along thoroughfares where unauthorized and unsightly posters and handbills often visually clutter the area. The semirigid wrap includes a single or multilayered panel which is wrapped around the circumference of a support member, is resistant to penetration by staples, and may include an anti-graffiti and other protective coatings. Additionally, the wrap may include aesthetic content or features which are decorative and/or informational. The content may include art and/or information that is culturally, socially, or commercially useful. The wrap can be retrained to the structure by fasteners or adhesives, for example, tamper-resistant fasteners.

In one illustrative embodiment a wrap for a structure is provided, including a semirigid panel sized to span at least a portion of an outer periphery of the structure, at least one of a graphical feature and informational content are displayed on the panel, and a fastening device for mounting the panel to the structure. The panel may include at least a first layer and a second layer. The second layer may be substantially transparent and may provide at least one of environmental, chemical, and graffiti protection. The at least one of a graphical feature and informational content may be positioned between the first layer and the second layer. The panel may further include a third layer having openings defined therethrough and a fourth panel layer having a color or graphic design on at least one surface.

The graphical feature may include artwork or camouflage. The at least one of a graphical feature and informational content may include wayfinding or at least one of advertising and sponsorship content. The panel may be sized to at least entirely span the periphery of the structure or may be sized to substantially span the periphery of the structure. The panel may be resistant to penetration of pointed fasteners. The structure may include a utility pole, light pole, bridge support, sign support member, column, beam and pillar.

In another illustrative embodiment, an aesthetic and protective wrap for a structure is provided, including a panel having at least two layers and configured to be conformed to an outer periphery of the structure, at least one of a graphical design and informational content associated with the panel, and a fastening means for attaching the panel to the periphery of the structure.

The panel may be semirigid and may be resistant to penetration by pointed fasteners. The at least two layers may include an outer layer having and at least a portion of the outer layer being substantially transparent. The at least two layers may alternatively or additionally include a layer having areas of removed material defining openings therethrough. The at least two layers may alternatively or additionally include a feature providing at least one of environmental, chemical, and graffiti protection. The at least one of a graphical feature and informational content may include at least one of artwork, advertising content, sponsorship content, wayfinding content, and camouflage. The structure is chosen from a group consisting of a utility pole, light pole, bridge support, sign support member, column, beam and pillar.

In yet another illustrative embodiment, a method of providing aesthetic or informational protective wraps for structures is provided, including the steps of acquiring permission to use existing structures along a thoroughfare, selling at least one of advertising and sponsorship to be displayed on the structures, and providing a wrap for mounting on the structures, the wrap including content relating to the at least one of advertising and sponsorship.

In a further illustrative embodiment, a method of providing aesthetic or informational protective wraps for structures is provided, including the steps of acquiring permission to use existing structures along a thoroughfare, developing an aesthetic or informational theme to be displayed on the structures, and providing a wrap for mounting on the structures, the wrap including a semirigid panel size to span at least a portion of the structure and the aesthetic or informational theme displayed by the panel.

### BRIEF DESCRIPTION OF THE DRAWINGS

The detailed description particularly refers to the accompanying figures in which:

FIG. 1 is a perspective view of an illustrative embodiment of a wrap mounted on a utility pole in a business district;

FIG. 2 is a perspective view of the utility pole and business district of FIG. 1 before application of the wrap;

FIG. 3 is an exploded perspective view of the wrap of FIG. 1 illustrating various layers of the wrap;

FIG. 4 is a cross-sectional view of a portion of the wrap of FIG. 1, illustrating one illustrative means of fastening the wrap to the utility pole;

FIG. 5 is a perspective view illustrating one illustrative means of fastening the wrap of FIG. 1 to the utility pole; and

FIG. 6 is a perspective view illustrating another illustrative means of fastening the wrap of FIG. 1 to the utility pole.

### DESCRIPTION OF THE ILLUSTRATIVE EMBODIMENTS

For the purposes of promoting and understanding the principals of the invention, reference will now be made to the one or more illustrative embodiments illustrated in the drawings and specific language will be used to describe the same.

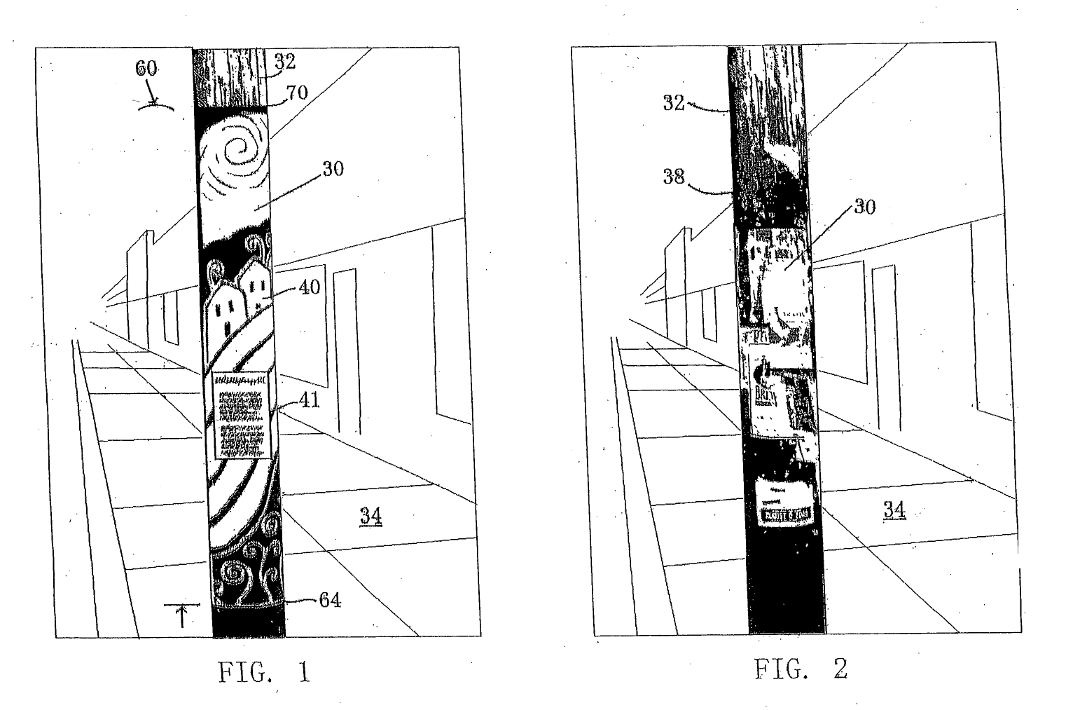

Referring to FIG. 1, the present invention provides an aesthetic and informational protective wrap 30 for structures 32, such as utility poles. Mounting of the wrap 30 on the structure 32 is especially advantageous in thoroughfares 34, for example, a street or sidewalk in a business district. Referring to FIG. 2, the structure 32, a wooden utility pole, is shown before application of the wrap 30. Unsightly and unauthorized handbills 36 often visually clutter this type of structure 32 in this type of thoroughfare 34. Additionally, even if the handbills 36 are removed from the structure 32, unsightly and potentially dangerous staples 38 or other pointed fasteners remain embedded or otherwise adhered to the structure 32. Referring again to FIG. 1 the outwardly facing side of the wrap 30 may include graphical features 40 that include decorative or aesthetic markings or texture and may include art and/or information 41 that is culturally, socially, or commercially useful.

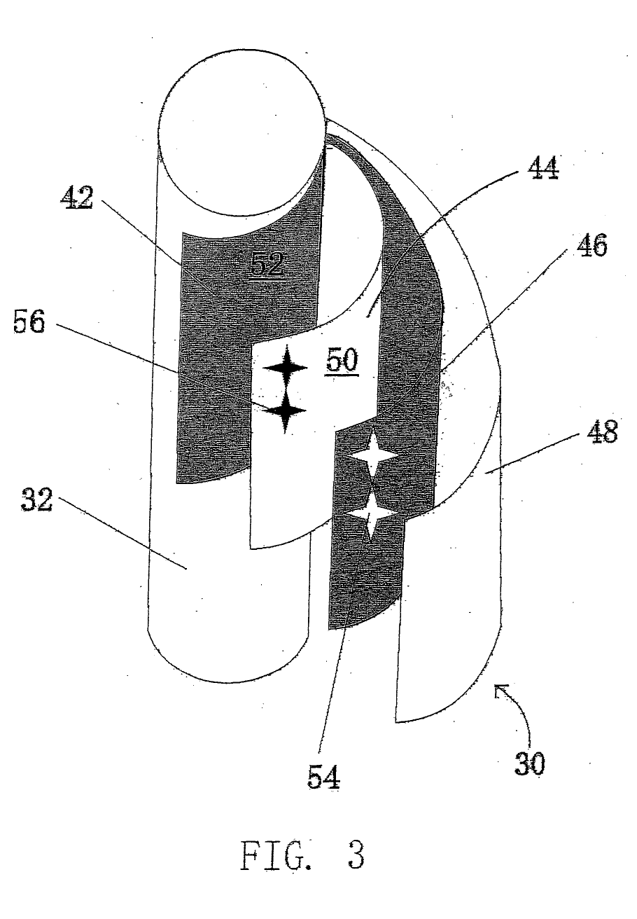

Referring to FIG. 3, the wrap 30 generally comprises a semirigid sheath of one or more panel layers 42, 44, 46 and 48. The layers 42, 44, 46 and 48 may be arranged adjacently, face to face, so that at least a portion of the faces of adjacent layers are overlappingly in contact. For the purpose of this application, semirigid is defined as flexible and conformable to the outer periphery of a structure, but resistant to being crumpled or collapsed. Each panel 42-48 may be constructed from a sheet-substrate material that is not permeable to liquid and that has some flexibility so that the wrap 30 is easily conformable to the cylindrical or other shape of the outer circumference of the structure 32. For example aluminum, steel, stainless steel, copper, tin, iron, durable plastic or vinyl, thermoplastic, such as polyolefin polyvinylchloride, polyesters such as polyethylene terephthalate, fiberglass, resin, other metal material, or other non-woven materials, with the exception of woven fibers such a spoly-aramid fiber such as Kevlar (a registered trademark of DuPont, Advanced Fiber Systems, Richmond Va.), or polyolefin fibers or other composite material.

The panels 42-48 may also incorporate special material or elements that provides various graphical or material features such as lenticular or holographic images that change with viewing angle, camouflage, cover or concealment, flexible messaging or video display, solar power cells for displays such as light-emitting diode and liquid crystal displays, vacuum formed or molded materials, and cast or extruded materials to provide shape, such as tubes or pipes.

Individual panels 42-48 that are formed into the wrap 30 are sufficiently durability to be mounted on the structure 32, and if used in an outdoor or other environmentally harsh location, to withstand environmental conditions such as moisture, wind, and sunlight.

Referring to FIG. 3, each individual panel layer 42-48 includes features that when combined and formed into wrap 30 provide the desired graphical features 40 (FIG. 1) and durability. In one illustrative embodiment, the wrap 30 includes a base panel 42, a color panel 44, a cut panel 46, and an outer panel 48; however, other combinations of panels and panel features may also be utilized.

The base panel 42 may be constructed of one of the above-listed substrate materials and may be formed as a solid or routed or otherwise adapted sheet which forms a suitable foundation for the additional panel layers 44-48. In the event that the wrap 30 is placed directly over the staples 38 and the handbills 36, shown in FIG. 2, the base panel 42 may be formed to be sufficiently sturdy and durable to be undamaged when applied firmly to the structure 32. The base panel 42 may be coated or otherwise treated on the inner and/or outer surface to protect the wrap 30 or to provide the graphical features 40 (FIG. 1).

The color panel 44 may provide a general base color 50 or design feature 56 and may be constructed of one of the above-listed substrate materials. The color 50 or design feature 56 may be incorporated into the color panel 44 during the substrate manufacturing process, or the color 50 or the design features 56 may be applied to or formed in the color panel 44 after forming the substrate material. As shown in FIG. 3, the color panel 44 may be coupled to the outer surface 52 of the base panel 42.

The cut panel 46 may be constructed from one of the above-listed materials and may include cut features 54, for example routed or die-cut partially or completely cut through or otherwise formed openings in the cut panel 46. The cut features 54 may include removal of portions of the cut panel 46. The cut features 54 are useful for exposing an underlying color or design contained within the cut panel 46 or exposing the color 50 or the design feature 56 of the panel 44. Both the cut features 54 and the underlying color 50 or design feature 56 form, at least in part, the graphical features 40 (FIG. 1). The graphical features 40 may also include reflective, lighted, or otherwise highly visible features that draw attention to an make visible the wrap 30 to persons transmitting the thoroughfare 34.

The graphical features 40 may also or alternatively include concealing, covering, or camouflaging features that reduce the visibility of the structure 32. For example, the graphical features 40 may be selected based on the surroundings in the thoroughfare 34 in order to reduce visibility against the background surroundings. For example, the graphical features 40 may include a panoramic photograph or digital print that matches the background when viewed from various viewing angles, or a fractal or micro pattern, for example using digital camouflage as is known in the art.

The outer panel 48 may serve as a protective outer layer, for example, the outer layer maybe or may include a substantially transparent material having properties or coatings or films to protect the underlying graphical features 40 from harmful UV or other environmental conditions, and from vandalism, for example graffiti. In one illustrative embodiment, the other panel 48 includes an outer layer providing a smooth surface and including anti-graffiti protection and filtering of UV light. For example, acrylic polyurethane, available from Mathews Paint of Pleasant Prairie, Wis., may be used for anti-graffiti and chemical resistance protection, Scotchgard anti-graffiti film, available from 3M of St. Paul, Minn., may be used for anti-graffiti protection, and 220-F Fluorescent UV Topcoat Clear, available from One Shot LLC of Gary, Ind. may be used for UV protection. The other panel 48 may be constructed from one of the above-listed materials.

The above-described features of the panels 42-48 may alternatively be applied to any one of the other panel layers so that more than one panel layer includes the same feature, or features from several of the above-described panel layers may be combined into fewer panels. For example, in one illustrative embodiment of the wrap 30 (not shown) the wrap 30 includes three panel layers: a combined base panel, which includes the features of the base panel 42 and the color panel 44 described above, a cut panel and an outer panel.

In addition to the above-listed features, the applied features 56, shown on the color panel 44 in FIG. 3, may be applied to an inner or other surface of any of the panels 42-48. The applied features 56 may include a decorative or protective overlay film or applied or laminated paint, varnish, plastic, vinyl, digital print graphics vacuum formed or molded layers, abrasion coating, patina, chemical resistant coating, or other coating, layer, or treatment known in the art. Treatments applied to the panels 42-48 may also include one or more of etching, embossing stamping, scuffing, relieving, hammering, spinning, brushing, chemical bathing, burnishing, grinding, cutting, dying, spraying, and electrostatically applying.

Referring again to FIG. 3, one or more of the panel layers 42-48 may be sandwiched or otherwise formed together to provide the resulting wrap 30, shown in FIG. 1, having the graphical features 40. For example, the panel layers 42-48 and other features may be held together by adhesive, mechanical fastening, chemically bonding, hot or cold lamination, and other devices or processes known in the art.

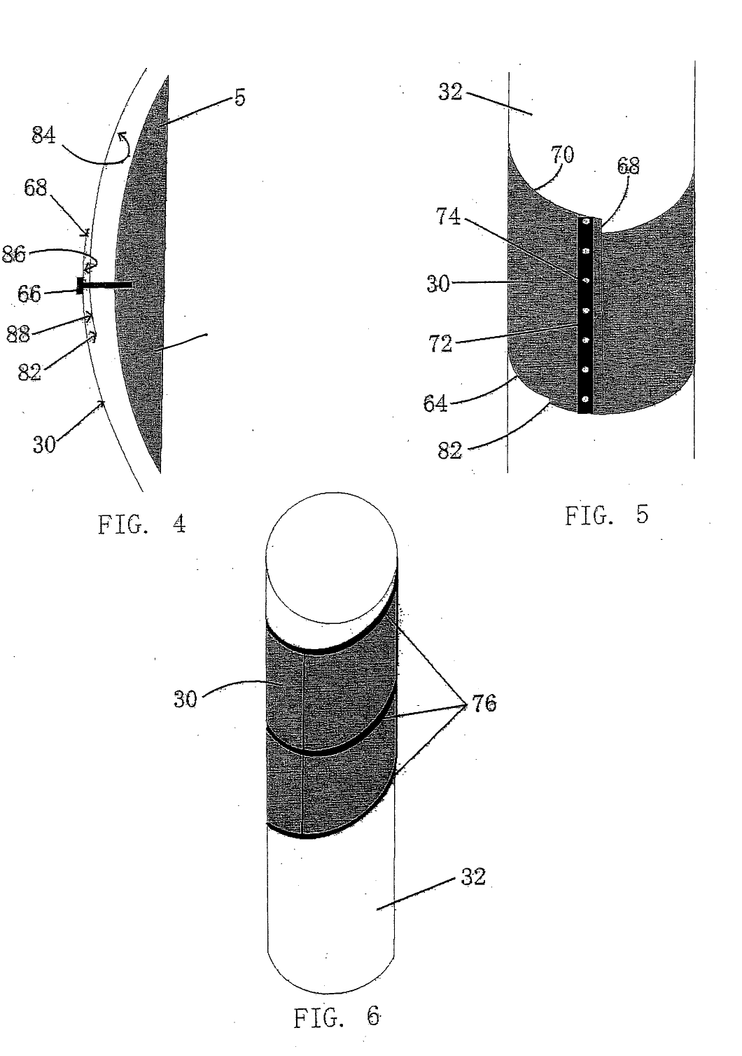

Referring to FIG. 1, the size of the wrap 30 is dependent upon the particular application and dimensions of the structure 32. In one illustrative embodiment, the structure 32 is a utility pole and the wrap 30 has a width sufficient to substantially surround the periphery of the structure 32, for example as shown in FIG. 4, and a height 60 (FIG. 1) sufficient to cover an area of the structure 32 generally susceptible to undesirable handbills and posters, or sufficient to provide visually aesthetic appeal. For example, the height 60 may be approximately 6 feet (1.83 meters) and the bottom edge 64 of the wrap 30 may be located at a desired elevation above the ground line, for example, approximately 2 feet (0.6 meters). Alternatively, the width may be selected to cover any portion of the periphery of the structure 32, from 1° to more than 360°, for example providing overlap of opposite edges 68 and 82 as shown in FIG. 4. For some materials, for example certain metals, layer thickness of about 0.040 inches (0.1 cm) provides desirable rigidity, flexibility, and resistance to crumpling and to penetration by staples and the like. However, layer and the wrap 30 thickness may vary depending on material, number of layers, application, and other considerations. For example, typical layer thickness may be between 0.010 inches (0.025 cm) and 0.080 inches (0.20 cm) and typical wrap 30 thickness may be between 0.010 inches (0.025 cm) and 0.25 inches (0.64 cm).

Depending on the material, the thickness, and the shape of the periphery of the structure 32, the wrap 30 may be conformable to the structure 32 by hand, by heat, by using compression bands or other tools, or by preshaping wrap 30 to conform to the structure 32. In one illustrative embodiment the wrap 30 is pretension to conform and/or to be retained on the structure 32 such that opposite edges 68 and 82 are pulled apart against the pretensioning in order to install the wrap 30 on the structure 32.

While the panels 42-48 are generally of the same width and height, one or more of the panels may be of smaller or larger dimensions and formed together to provide the desired finished width and height. The width and height of the wrap 30 may be available in a range of standard sizes for typical installations, or may be custom sized to provide the sight lines most suitable for a particular structure 32 and installation location, or, for example, to facilitate wrapping of utility poles having varying diameters.

Referring to FIGS. 4-6, the wrap 30 may be mounted to the structure 32 by any suitable means for retaining the wrap 30 around the periphery of the structure 32. For example, the wrap 30 may include securing features 66 located adjacent the first edge 68 and extending between the bottom edge 64 and the top edge 70 (FIG. 5). The securing feature 66 may be, for example, through-holes accommodating fasteners.

The wraps 30 may be mounted using any suitable mechanical means; however, a tamperproof and low-relief fastening method or adhesive is desirable. Alternatively, an additional feature such as a splice along the length of the edges 68 and 82 band(s) 76 extending circumferentially around the wrap, a retaining channel, or a retaining strap at the seam may be used to secure the wrap 30 to the structure 32 and to provide seam management. Advantageously, the fastening device(s) may be releasable so that the wrap 30 may be easily removed or replaced.

Fasteners may include but are not limited to secure fasteners and common fasteners and fastening techniques, for example, tacks, nails, screws, rivets, adhesive bonds, and spot welds. The fasteners may be continuously or periodically applied to secure the first edge 68 to the opposite second edge 82, as shown in FIG. 4. While the first edge 68 and the second edge 82 may abut one another or be spanned by a splice, adhesive or other fastening device, for example, retaining strap 72 and associated fasteners 74 shown in FIG. 5. The first edge 68 and the second edge 82 may also overlap as shown in FIGS. 4-5. The strap 72 may be constructed of any of the above listed materials used for the wrap 30 and the associated fasteners 74 may include any of the above listed fasteners. In one illustrative embodiment the strap 72 is shaped to cover and prevent exposure of the potentially sharp edge 68. Other fastening mechanisms may also be used to secure the wrap 30 to the structure 32. For example, bands 76 (FIG. 6) extending circumferentially around the wrap 30 may be used to tension the wrap 30 against the supporting structure 32, an adhesive applied between an inside surface 84 of the wrap 30 and the supporting structure 32, an adhesive applied between an inside surface 86 and an outer surface 88 of the wrap 30 between the first edge 68 and the second edge 82, brackets, pins, staples, tape, clamps, ties, or other fastening devices and techniques known in the art.

Although the wrap 30 may be mounted to the structure 32 such as a utility pole located along the thoroughfare 34, the wrap 30 may also be associated with other structures and other locations. Generally, the wrap 30 is mounted to a preexisting support member; however, the structure 32 could be constructed for the purpose of mounting and displaying the wrap 30. The outer periphery of the structure 32 may include the circumference of the structure. For the purpose of this application, a structure is any structural or utility support member, including but not limited to a pole, column, beam, or pillar having a variety of cross-sections, and therefore, variety of outer periphery shapes, for example, circular or otherwise arcuate, or square, or otherwise rectilinear or multifaceted. For cross-sections of structures 32 that are not circular, the wrap 30 may include brake formed, welded, molded, pressed, or otherwise fabricated sections to conform to complex shapes. The structures 32 may include pre-existing attached elements, such as signage or grounding cables. The wrap 30 may be fabricated or otherwise conformable to be located over, under, or around such elements. Such elements may also be incorporated into the wrap 30. The structure 32 may be substantially vertical, horizontal, or obliquely oriented to the ground surface. Additionally, the structure 32 can be located on the interior or exterior of a structure, or be free standing, such as a utility pole shown in FIG. 1. Examples of thoroughfares 34 include roads, streets, sidewalks, trails, and waterways.

Referring to FIG. 1, aesthetic aspects of the wrap 30 may include both graphical features 40 and informational content 41. The graphical features 40 may include, for example, artwork, or other graphic content that is aesthetically appealing or may relate to the informational content 41 or an aspect of the thoroughfare 34 in which the support structure 32 is located. For example, the wrap 30 may include graphical features 40 and/or informational content 41 that relate to the community, district, venue, entity, or event at which the wrap 30 and the supporting structure 32 are located or otherwise associated. For example, the graphical features 40 and/or the informational content 41 may be associated with historic, cultural, residential, business or other commercial or non-commercial aspects which are aesthetically or informationally supported by the placement of the wrap 30. The graphical features 40 and the informational content 41 may include branding, sponsorship, announcements, advertising, wayfinding, navigation, safety, warning, or other types of content or messages. Wayfinding includes guides, transportation and other schedules, maps, directions, navigation, points of interest, and events. The graphical features 40 and the informational content 41 may help to convey to those viewing the wrap 30 the entity, activity, location, or concept which is advanced by and associated with the wrap 30. For example, the informational content 41 may communicate a district or neighborhood name and the graphical features 40 may further support community identity or branding with an associated artistic work.

The wrap 30 may be also incorporated into a method of doing business. For example, the graphical features 40 or the informational content 86 may be provided in the form of sponsorship or advertising in order to generate a revenue stream for the owners of or other party having an interest or other right in the wrap 30 or the structure 32. For example, a party locates a commercial or other entity that desires to advertise using the wraps 30 on utility poles or other structures, the party leases or otherwise secures from the owner permission to use utility poles or other structures, the wraps 30 are prepared to include advertising or other informational content or graphic design relating to the commercial entity, the wraps 30 are attached to the structures 32, and fees or other benefits are collected. A similar method of doing business may be utilized for noncommercial entities, for example providing informational content or improved aesthetics in a thoroughfare. The providing of the wraps 30 may include fabricating and/or installing the wraps 30, for example, as described above. And some of or all of the above steps may be implemented at least in part using a machine, for example, a computer having a processor, memory, and associated software for enabling the computer to perform the process or portions thereof. For example, a database may be developed that includes at least one of a listing of existing structures 32 or structures 32 for which permission to use has been acquired or is desired, a listing of at least one of advertising and sponsorship, or the entities or wraps 32 related thereto, and a listing of the aesthetic or informational themes, or of the entities or wraps 30 related thereto.

Commercial and non-commercial entities that may benefit by or promote the wraps 30 include businesses co-located or adjacent to the utility pole or other structure 32, neighborhood associations, chambers of commerce, local tourism agencies, city planners, landscape architects, civic groups, public safety interest groups, artists, event sponsors, commercial entities that engage in mass media marketing to promote branding, and the like. While the wraps 30 located in cosmopolitan areas may be more likely to be directed to wayfinding, co-located business entities and events, local points of interest, and aesthetic improvement of thoroughfares, the wraps 30 located in rural areas might be more likely to be directed at wayfinding and to promote branding by large commercial entities, for example, by repeating the same or related messages and branding marks along stretches of rural thoroughfares. Depending upon how the wraps 30 are attached to the structures 32, replacement and/or rotation of the wraps 30 may be accommodated to provide rotation of the artwork or other aesthetic aspects of the wraps 30 and to promote changing events, seasonal interests, or other such interests.

Utility companies or other owners of the utility poles or other structures 32 are likely to support the use of the wraps 30 on at least a couple of basis. For example, the wraps 30 may assist in limiting liability issues associated with utility poles by preventing the exposure of or insertion of hazardous splinters, staples, nails, and the like. Additionally, fees colleted for placement of the wraps 30 on utility poles and securing the rights for the use of the utility poles may provide a revenue source to utility companies to offset the maintenance and or replacement of utility poles. However, utility companies may not require revenue to agree to the use of the utility poles given the reduction of liability and the community interests that are served by the safety, aesthetic, and informational aspects provided by the wraps 30. Advantageously, bucket trucks are generally used to service utility poles and the supported utilities; therefore, pole climbing is rarely used for maintenance and the wraps 30 do not provide an obstacle to the use of bucket trucks.

Rates for the production, installation, and display of the wraps 30 may be determined based on industry standard traffic and square footage exposed rates, or may be based on specially negotiated rates. Depending on the aesthetic and informational content of the wraps 30, it may be necessary to license or otherwise acquire intellectual property rights in images or other contents associated with the graphical features 40 and informational consent 41 of the wraps 30. It may also be necessary to ensure the wraps 30 conform to local sign ordnances or to successfully lobby for accommodation of the wraps 30 under local ordnances. However, aesthetic and non-commercial wraps 30 may not fall under and not be subject to local sign ordnances that are generally directed to commercial signage.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

1. A wrap for a structure, comprising:
a semirigid panel sized to span at least a portion of an outer periphery of the structure;
at least one of a graphical feature and informational content displayed on the panel; and
a fastening device for mounting the flexible panel to the structure.

2. The wrap of claim 1, wherein the panel includes at least a first layer and second layer.

3. The wrap of claim 2, wherein the panel further includes a third layer having openings defined therethrough.

4. The wrap of claim 2, wherein the panel further includes a fourth panel layer having a color or graphic design on at least one surface.

5. The wrap of claim 2, wherein the second layer is substantially transparent and provides at least one of environmental, chemical, and graffiti protection.

6. The wrap of claim 2, wherein the at least one of a graphical feature and informational content is positioned between the first layer and the second layer.

7. The wrap of claim 1, wherein the graphical feature includes artwork.

8. The wrap of claim 1, wherein the at least one of a graphical feature and informational content includes at least one of advertising and sponsorship content.

9. The wrap of claim 1, wherein the at least one of a graphical feature and informational content includes wayfinding.

10. The wrap of claim 1, wherein the graphical feature includes camouflage.

11. The wrap of claim 1, wherein the panel is sized to at least entirely span the periphery of the structure.

12. The wrap of claim 1, wherein the panel is sized to substantially span the periphery of the structure.

13. The wrap of claim 1, wherein the panel is resistant to penetration of pointed fasteners.

14. The wrap of claim 1, wherein the structure is chosen form a group consisting of a utility pole, light pole, bridge support, sign support member, column, beam and pillar.

15. The wrap of claim 1, wherein the periphery of the structure comprises a circular shape.

16. An aesthetic and protective wrap for a structure, comprising:
a panel having at least two layers and configured to conform to a outer periphery of the structure;
at least one of a graphical design and informational content associated with the panel; and
a fastening means for attaching the panel to the circumference of the structure.

17. The aesthetic and protective wrap of claim 16, wherein the panel is semirigid.

18. The aesthetic and protective wrap of claim 17, wherein the panel is resistant to penetration by pointed fasteners.

19. The aesthetic and protective wrap of claim 17, wherein the at least two layers include an outer layer and at least a portion of the outer layer is substantially transparent.

20. The aesthetic and protective wrap of Claim 17, wherein the at least two layers includes a layer having areas of removed material defining openings therethrough.

21. The aesthetic and protective wrap of claim 17, wherein the structure is chosen from a group consisting of a utility pole, light pole, bridge support, sign support member, column, beam and pillar.

22. The aesthetic and protective wrap of claim 17, wherein the at least one of a graphical feature and informational content includes at least one of artwork, advertising content, sponsorship content, wayfinding content, and camouflage.

23. The aesthetic and protective wrap of claim 16, wherein the at least two layers include a feature providing at least one of environmental, chemical, and graffiti protection.

24. The aesthetic and protective wrap of claim 17, wherein the outer periphery of the structure comprises a substantially circular shape.

25. A method of providing aesthetic or informational protective wraps for structures, comprising the steps of:
acquiring permission to use existing structures along a thoroughfare;
selling at least one of advertising and sponsorship to be displayed on the structures; and
providing a wrap for mounting on the structures, the wrap including content relating to the at least one of advertising and sponsorship.

26. The method of claim 25, wherein the providing step includes fabricating the wrap from at least one semirigid panel sized to span at least a portion of the outer periphery of the structure.

27. The method of claim 25, further comprising developing a database of at least one of the existing structures for which permission to use is acquired and the at least one of advertising and sponsorship.

28. A method of providing aesthetic or informational protective wraps for structures, comprising the steps of:
acquiring permission to use existing structures along a thoroughfare;
developing an aesthetic or informational theme to be displayed on the structures; and
providing a wrap for mounting on the structures, the wrap including the aesthetic or informational theme displayed by the panel.

29. The method of claim 28, wherein the providing step includes fabricating the wrap from at least one semirigid panel sized to span at least a portion of the outer periphery of the structure.

30. The method of claim 28, further comprising developing a database of at least one of the existing structures for which permission to use is acquired and the aesthetic or informational theme.
